(19) United States
(12) Patent Application Publication
(10) Pub. No.: US 2015/0205161 A1
(43) Pub. Date: Jul. 23, 2015

(54) DISPLAY DEVICE

(71) Applicant: Japan Display Inc., Minato-ku (JP)

(72) Inventors: Mitsutaka OKITA, Tokyo (JP); Kazuhiro Nishiyama, Tokyo (JP)

(73) Assignee: Japan Display Inc., Minato-ku (JP)

(21) Appl. No.: 14/602,369

(22) Filed: Jan. 22, 2015

(30) Foreign Application Priority Data
Jan. 23, 2014 (JP) 2014-010691

(51) Int. Cl. G02F 1/1335; G02F 1/1333; G02F 1/1368

(52) U.S. Cl. CPC G02F 1/133512; G02F 1/1368; G02F 1/133514; G02F 1/133345; G02F 2001/133519

(57) ABSTRACT

If a black matrix is thinned down in order to increase the aperture ratio, color mixture is likely to occur in which during monochromatic representation a desired color from relevant sub-pixels and a different color from adjacent sub-pixels appear to be mixed together when viewed obliquely. A display device includes a display panel and a light source. The display panel includes an array substrate, an opposite substrate, and a liquid crystal layer. The opposite substrate includes a first light blocking layer and a colored layer. The array substrate includes a second light blocking layer and a signal wiring layer. The first light blocking layer, the second light blocking layer, and the signal wiring layer are disposed between sub-pixels of different colors. The second light blocking layer is disposed close to the liquid crystal layer. A distance between top surfaces of the first and second light blocking layers is decreased.

### CLAIM OF PRIORITY

The present application claims priority from Japanese patent application JP2014-010691 filed on Jan. 23, 2014, the content of which is hereby incorporated by reference into this application.

### BACKGROUND

The present disclosure relates to display devices and is applicable to, for example, liquid crystal display devices with a black matrix on an opposite substrate.

Published Japanese Patent Application No. 2010-14760 and the corresponding U.S. Pat. No. 8,269,925 disclose a technique in which in order to avoid color mixture which may appear when a display surface is viewed obliquely, for example, the width of a black matrix is increased between red and blue pixels but not increased between red and green pixels, thereby increasing the aperture ratio of the pixels as compared with the case where the width of the black matrix is increased as a whole.

### SUMMARY

Liquid crystal display devices for smartphones and tablets are increasing their resolution and the pixel size thereof is becoming so fine that panels with a resolution of 300 ppi (pixels per inch) or more have been a commercial reality and even panels with a resolution of 500 ppi have been developed. As the pixel size decreases, the ratio of signal wiring and black matrix to the pixel area increases and thus the pixel aperture ratio decreases. Therefore, it is necessary to thin down the signal wiring and the black matrix in order to increase the aperture ratio.

In assembling together an array substrate including signal wiring or the like and an opposite substrate including a black matrix or the like, assembly misalignment may occur. If in such a case the black matrix is thinned down for the purpose of increasing the aperture ratio, color mixture is likely to occur in which during monochromatic representation a desired color from the relevant sub-pixels and a different undesired color from adjacent irrelevant sub-pixels appear to be mixed together when viewed obliquely.

Other problems and novel features will be apparent from the description of the present disclosure and the accompanying drawings.

A brief description will be given below of a summary of a representative one of aspects according to the present disclosure.

A display device includes a display panel and a light source. The display panel includes an array substrate, an opposite substrate, and a liquid crystal layer sandwiched between the array substrate and the opposite substrate. The opposite substrate includes a first light blocking layer, a colored layer, and an overcoat layer. The array substrate includes a second light blocking layer and a signal wiring layer. The light source is disposed on an opposite side of the array substrate to the liquid crystal layer. The first light blocking layer, the second light blocking layer, and the signal wiring layer are arranged between sub-pixels of different colors. The second light blocking layer is disposed close to the liquid crystal layer. A distance between a top surface of the first light blocking layer and a top surface of the second light blocking layer is decreased by increasing a thickness of the first light blocking layer, decreasing a thickness of the colored layer, decreasing a thickness of the overcoat layer or decreasing a thickness of the liquid crystal layer.

### BRIEF DESCRIPTION OF THE DRAWINGS

FIG. 1A is a cross-sectional view showing the structure of a display device according to a comparative example.

FIG. 1B is an enlarged cross-sectional view of a portion of FIG. 1A indicated by the broken line A.

FIG. 1C is a cross-sectional view for illustrating a problem of the display device according to the comparative example.

FIG. 1D is a cross-sectional view for illustrating another problem of the display device according to the comparative example.

FIG. 1E is a cross-sectional view for illustrating still another problem of the display device according to the comparative example.

FIG. 2 is a cross-sectional view showing the structure of a display device according to an embodiment.

FIG. 3 is a cross-sectional view for illustrating effects of the display device according to the embodiment.

FIG. 4A is a plan view showing substrates of a display device according to an example with the substrates separated from each other.

FIG. 4B is a side view of the display device according to the example.

FIG. 5A is a plan view showing a portion of an array substrate in the example.

FIG. 5B is a cross-sectional view showing a portion of the display device according to the example.

FIG. 6A is a cross-sectional view for illustrating a method for producing an opposite substrate.

FIG. 6B is another cross-sectional view for illustrating the method for producing an opposite substrate.

FIG. 6C is still another cross-sectional view for illustrating the method for producing an opposite substrate.

FIG. 6D is still another cross-sectional view for illustrating the method for producing an opposite substrate.

FIG. 6E is still another cross-sectional view for illustrating the method for producing an opposite substrate.

FIG. 7A is a cross-sectional view of a display device having no assembly misalignment.

FIG. 7B is a cross-sectional view of a display device having assembly misalignment.

FIG. 8 is a graph showing the relation between the thickness of a light blocking layer and the color mixture ratio.

FIG. 9 is a graph showing a relation among the thickness of the light blocking layer, the width of the light blocking layer, and the color mixture ratio.

FIG. 10 is a graph showing another relation among the thickness of the light blocking layer, the width of the light blocking layer, and the color mixture ratio.

### DESCRIPTION OF THE PREFERRED EMBODIMENTS

Hereinafter, a description will be given of an embodiment, an example, a comparative example with reference to the drawings. It will be understood that the disclosure is merely illustrative and that appropriate changes and modifications easily conceivable by those skilled in the art without departing from the gist of the invention are encompassed within the scope of the invention. It should be noted that although for further clarity of explanation the width, thickness, shape, and so on of each component may be schematically shown in the drawings as compared with the reality, these dimensions, the shape and so on are merely illustrative and are not intended to restrict the interpretation of the present invention. In the specification and figures, the same elements as those already described with reference to already mentioned figure or figures may be designated by the same references and further explanation thereof may be omitted as necessary.

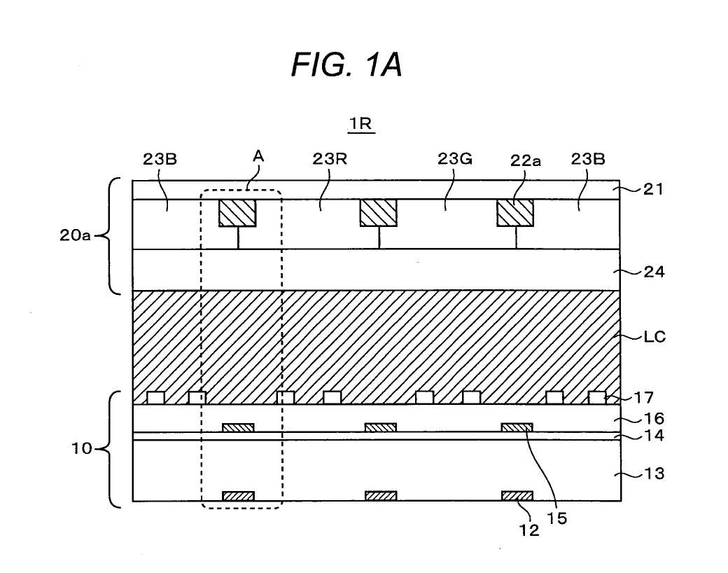

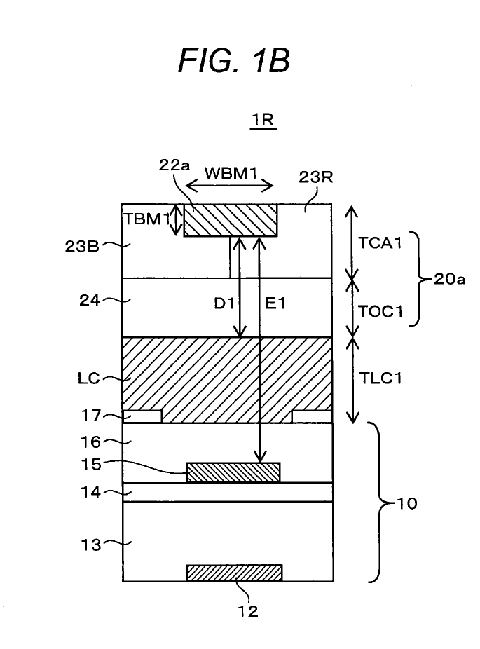

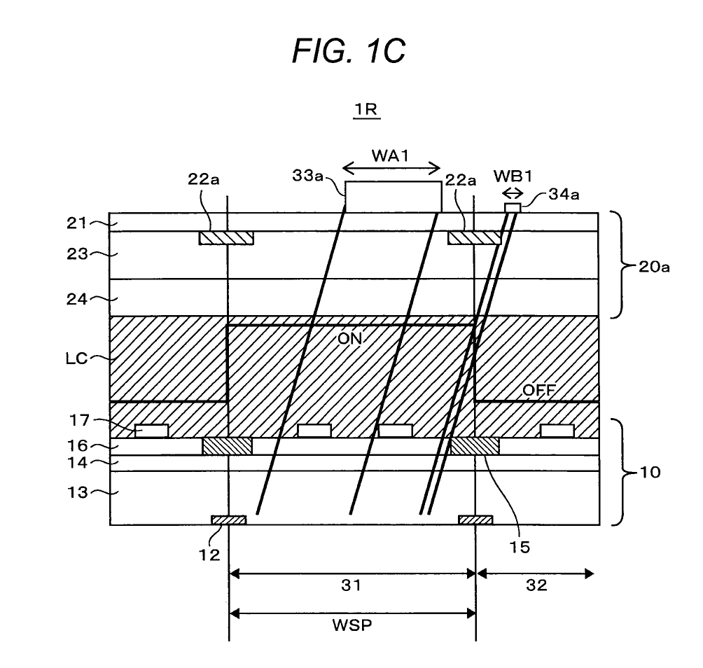

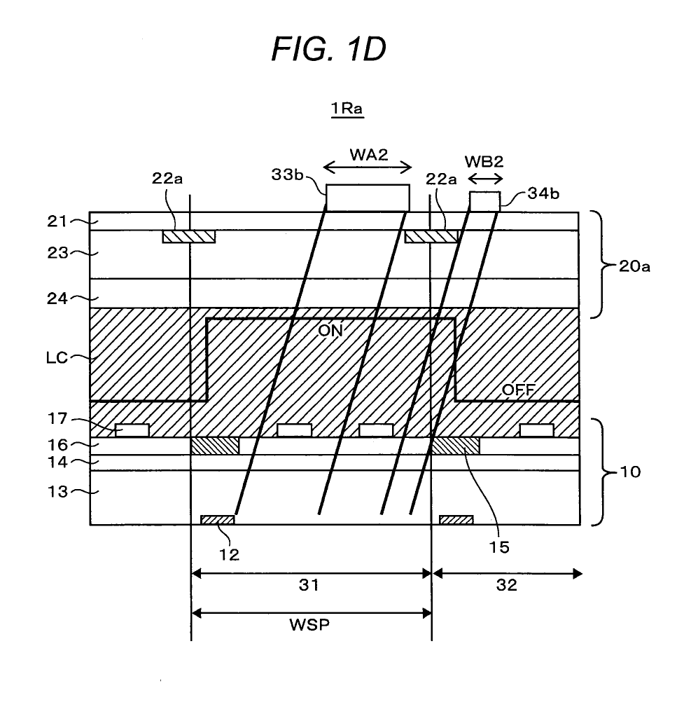

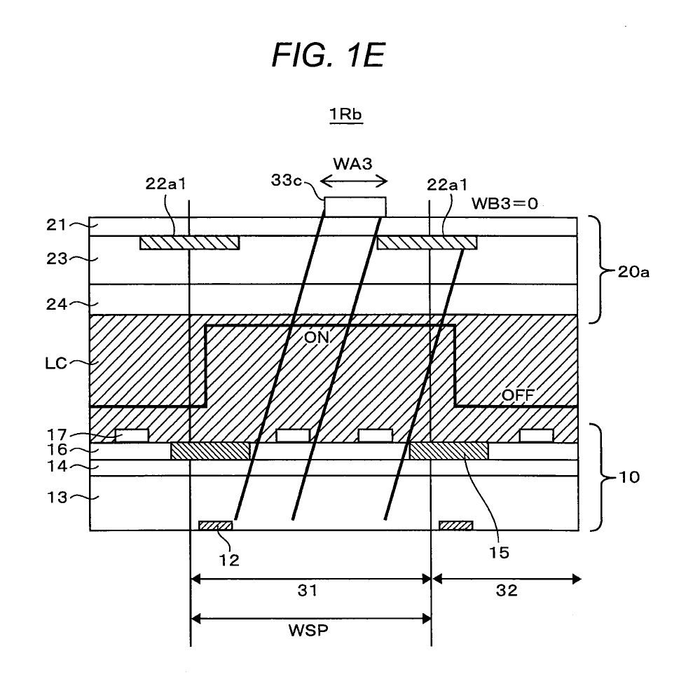

First, a description will be given of problems with a display device according to a comparative example with reference to FIGS. 1A to 1D.

FIG. 1A is a cross-sectional view showing the structure of the display device according to the comparative example. FIG. 1B is an enlarged cross-sectional view of a portion of FIG. 1A indicated by the broken line A. FIGS. 1C to 1E are cross-sectional views for illustrating the problems of the display device according to the comparative example.

The display device 1R according to the comparative example includes an array substrate 10, an opposite substrate 20a, and a liquid crystal layer LC. The array substrate 10 includes a signal wiring layer 12, a common electrode 14, and a plurality of pixel electrodes 17. An organic insulating layer 13 is disposed between the signal wiring layer 12 and the common electrode 14. An auxiliary wiring layer 15 is disposed straight above the signal wiring layer 12 and in contact with the common electrode 14. An interlayer insulating layer 16 is disposed between the common electrode 14 and the pixel electrodes 17. The signal wiring layer 12 and the auxiliary wiring layer 15 are each formed of a light-blocking conductive film. The common electrode 14 and the pixel electrodes 17 are each formed of a transparent conductive film.

The opposite substrate 20a includes a transparent substrate 21 of glass or so on, a light blocking layer (black matrix) 22a, a colored layer (color filter) 23, and an overcoat (OC) layer 24. The colored layer 23 is a generic term that covers a red-colored layer 23R, a green-colored layer 23G, and a blue-colored layer 23B. The light blocking layer 22a is disposed straight above the signal wiring layer 12 and the auxiliary wiring layer 15. The auxiliary wiring layer 15 and the light blocking layer 22a reduce color mixture to be described hereinafter.

Assume that the width of the light blocking layer 22a is WBM1, the thickness thereof is TBM1, the distance between the light blocking layer 22a and the liquid crystal layer LC is D1, the distance between the light blocking layer 22a and the auxiliary wiring layer 15 is E1, the thickness of the colored layer 23 is TCA1, the thickness of the overcoat layer 24 is TOC1, and the thickness of the liquid crystal layer LC is TLC1. The thickness TCA1 is not the thickness of the color layer 23 from the top surface (inner surface) of the light blocking layer 22a but the thickness thereof from the top surface (inner surface) of the transparent substrate 21. Although alignment films are formed on both surfaces of the liquid crystal layer LC, the thickness of the alignment films is much smaller than that of the liquid crystal layer and, therefore, the thickness TLC1 includes the thickness of the alignment films. In this case, TBM1<D1 and TBM1<TCA1.

As shown in FIG. 1A, the display device 1R is configured so that each pixel for color representation is composed of adjacent three sub-pixels of three colors R (red), G (green), and B (blue). The sub-pixels include their respective associated color filters (colored layers) 23R, 23G, 23B. The observer can recognize a specific color created by mixing the colors through these color filters. If only one of R, G, and B is desired to be represented monochromatically, this is implemented by turning on the liquid crystal molecules in the sub-pixel of the desired color (representing them in white) and turning off the liquid crystal molecules in the other sub-pixels of the other colors (representing them in black). A light source (backlight) is located below the array substrate 10, while the observer is located above the opposite substrate 20a. Therefore, the display device 1R is a transmissive liquid crystal display device. If the sub-pixels make vertical stripes, the signal wiring layer 12 is formed of video signal lines. If the sub-pixels make horizontal stripes, the signal wiring layer 12 is formed of scanning signal lines.

In the case of such a monochromatic representation, when, as shown in FIG. 1C, the observer views the display surface obliquely, a desired color from the relevant sub-pixel 31 in which liquid crystal molecules are turned on is mixed with a different color from the adjacent irrelevant sub-pixel 32 in which liquid crystal molecules are turned off and which is located closer to the observer's eyes than the sub-pixel 31, so that the resultant representation disadvantageously appears as an undesired mixed color to the observer. This disadvantage is referred to as color mixture. The reason for the occurrence of this disadvantage is that there is an optical path of light emitted from, for example, the backlight, and then passing through both the relevant sub-pixel 31 with the liquid crystal molecules turned on and the adjacent irrelevant sub-pixel 32 of a different color. Ina display region of the relevant sub-pixel 31, regular light 33a of a width WA1 is emitted from the display device 1R along an optical path formed between the signal wiring layer 12 and the light blocking layer 22a. In a display region of the adjacent sub-pixel 32, mixed color light 34a of a width WB1 is emitted from the display device 1R along an optical path formed between the light blocking layer 22a and the auxiliary wiring layer 15.

Because of production tolerance, as shown in FIG. 1D, the array substrate 10 and the opposite substrate 20a are sometimes assembled together as they are misaligned in a direction across sub-pixels of different colors (sometimes cause assembly misalignment). Depending upon the state of assembly misalignment, the color filter of the sub-pixel 32 of a different color adjacent to the sub-pixel 31 in which the liquid crystal molecules are to be turned on during monochromatic representation may be located close to or overlapped with a region of the liquid crystal layer where the liquid crystal molecules are to be turned on. Therefore, for example, in a display device 1Ra having assembly misalignment as shown in FIG. 1D, the width (WB2) of the optical path of mixed color light 34b is increased and, therefore, the disadvantageous color mixture appearing when the display surface is viewed obliquely from above the adjacent sub-pixel 32 having a different color from the relevant sub-pixel 31 is particularly significant. In a display region of the relevant sub-pixel 31, regular light 33b of a width WA2 is emitted from the display device 1Ra along an optical path formed between the signal wiring layer 12 and the light blocking layer 22a. In a display region of the adjacent sub-pixel 32, mixed color light 34b of a width WB2 is emitted from the display device 1Ra along an optical path formed between the light blocking layer 22a and the auxiliary wiring layer 15. In this case, WA2<WA1 and WB2>WB1.

As shown in FIG. 1E, if the width of a light blocking layer 22a1 of a display device 1Rb is made greater than the width of the light blocking layer 22a, color mixture can be reduced or avoided. However, the aperture ratio decreases. In a display region of the relevant sub-pixel 31, regular light 33c of a width WA3 is emitted from the display device 1Rb along an optical path formed between the signal wiring layer 12 and the light blocking layer 22a1. In a display region of the adjacent sub-pixel 32, no undesired mixed color light passing between the light blocking layer 22a1 and the auxiliary wiring layer 15 is emitted from the display device 1Rb. In this case, WA3<WA2.

The existence of the auxiliary wiring layer can prevent the occurrence of mixed color light to some extent or decrease the width of mixed color light. However, in order to increase the aperture ratio, it is necessary not only to decrease the width of the light blocking layer but also to decrease the width of the auxiliary wiring layer. If the width of the light blocking layer is decreased for the purpose of increasing the aperture ratio, color mixture is likely to occur. Alternatively, if the width (WSP) of each sub-pixel in the direction across sub-pixels of different colors is decreased, color mixture becomes significant. The width WSP is referred to also as a pixel pitch.

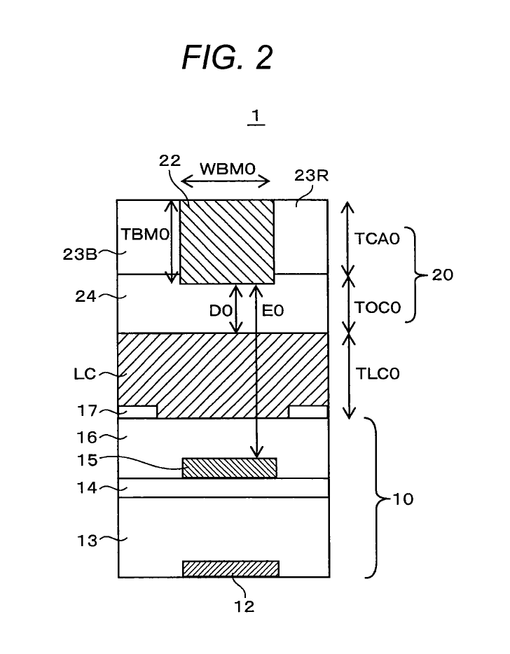

Next, a description will be given of a display device according to an embodiment with reference to FIG. 2.

FIG. 2 is a cross-sectional view showing the structure of the display device according to this embodiment.

The display device 1 according to this embodiment is different in the thickness of a light blocking layer from the display device 1R according to the comparative example but they have the same structure as for the rest.

Specifically, the display device 1 includes an array substrate 10, an opposite substrate 20, and a liquid crystal layer LC. The array substrate 10 includes a signal wiring layer 12, a common electrode 14, and a plurality of pixel electrodes 17. An organic insulating layer 13 is disposed between the signal wiring layer 12 and the common electrode 14. An auxiliary wiring layer (second light blocking layer) 15 is disposed above the signal wiring layer 12 and in contact with the common electrode 14. An interlayer insulating layer 16 is disposed between the common electrode 14 and the pixel electrodes 17. The signal wiring layer 12 and the auxiliary wiring layer 15 are each formed of a light-blocking conductive film. The common electrode 14 and the pixel electrodes 17 are each formed of a transparent conductive film.

The opposite substrate 20 includes a transparent substrate 21 of glass or so on, a light blocking layer 22, a colored layer 23, and an overcoat layer 24. The light blocking layer (first light blocking layer) 22 is disposed straight above the signal wiring layer 12 and the auxiliary wiring layer 15. The light blocking layer 22, the signal wiring layer 12, and the auxiliary wiring layer 15 are arranged between sub-pixels of different colors. The light blocking layer 22 is overlapped with the signal wiring layer 12 and the auxiliary wiring layer 15 in plan view. The auxiliary wiring layer 15 and the light blocking layer 22 reduce color mixture.

Assume that the width of the light blocking layer 22 is WBM0, the thickness thereof is TBM0, the distance between the light blocking layer 22 and the liquid crystal layer LC is D0, the distance between the light blocking layer 22 and the auxiliary wiring layer 15 is E0, the thickness of the colored layer 23 (i.e., a red-colored layer 23R, a green-colored layer 23G, and a blue-colored layer 23B) is TCA0, the thickness of the overcoat layer 24 is TOC0, and the thickness of the liquid crystal layer LC is TLC0. The thickness TCA0 is not the thickness of the color layer 23 from the top surface (inner surface) of the light blocking layer 22 but the thickness thereof from the top surface (inner surface) of the transparent substrate 21. Although alignment films are formed on both surfaces of the liquid crystal layer LC, the thickness of the alignment films is much smaller than that of the liquid crystal layer and, therefore, the thickness TLC0 includes the thickness of the alignment films. In this case, WBM0=WBM1, TBM0>TBM1, TCA0=TCA1, TOC0=TOC1, TLC0=TLC1, DO<D1, and EO<E1. The thickness TBM0 may be greater than TCA0 but is preferably smaller than TCA0+TOC0.

Next, a description will be given of effects of the display device according to this embodiment.

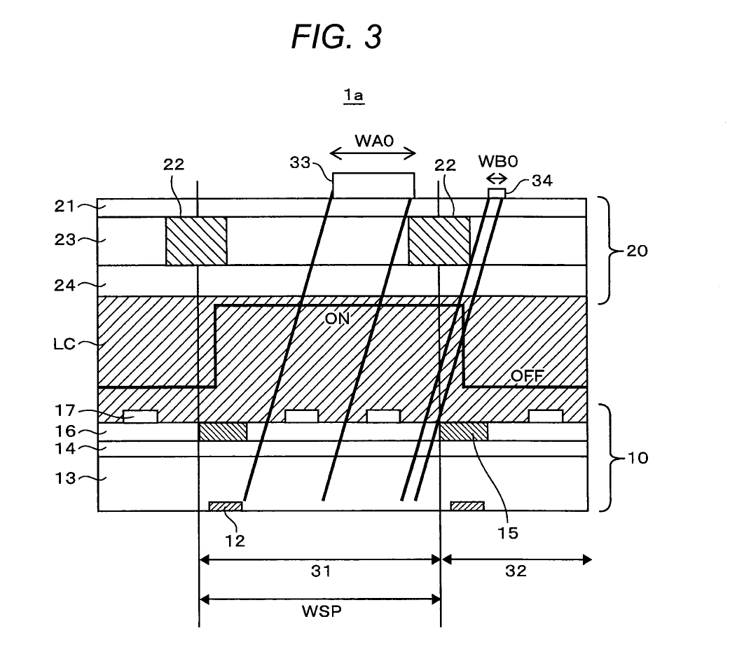

FIG. 3 is a cross-sectional view for illustrating the effects of the display device according to this embodiment.

Even if because of production tolerance the array substrate 10 and the opposite substrate 20 are assembled together as they are misaligned in the direction across sub-pixels of different colors as shown in FIG. 3, the width (WB0) of mixed color light 34 of the display device 1a can be decreased as compared with the width (WB2) of mixed color light of the display device 1Ra according to the comparative example by decreasing the distance (E0) between the top surface of the light blocking layer 22 of the opposite substrate 20 and the opposed top surface of the uppermost light blocking layer (auxiliary wiring layer 15) of the array substrate 10. In this case, WA0=WA1.

By decreasing E0, the display device with high definition and high aperture ratio can reduce color mixture without reducing the transmittance of the display panel. Because the turned-off liquid crystal molecules function as a light blocking layer, it is preferred to decrease the distance (D0) between the liquid crystal layer and the light blocking layer of the opposite substrate. As an example, the distances D0 and E0 can be decreased by increasing the thickness of the light blocking layer 22. As another example, the distances D0 and E0 can be decreased by decreasing the thickness of the colored layer 23. As still another example, the distances D0 and E0 can be decreased by decreasing the thickness of the overcoat layer 24. As even still another example, the distances D0 and E0 can be decreased by decreasing the thickness of the liquid crystal layer LC. By combining two or more of these examples, the distances D0 and E0 can be further decreased.

The thickness of the light blocking layer is preferably greater than the distance between the facing surfaces of both the light blocking layer and the liquid crystal layer. In this case, however, in order to planarize the surface of the opposite substrate facing the liquid crystal layer, the thickness of the light blocking layer is preferably smaller than the total thickness of the colored layer and the overcoat layer. More preferably, the thickness of the light blocking layer is smaller than the thickness of the colored layer.

Alternatively, the thickness of the light blocking layer is preferably greater than the thickness of the colored layer. In this case, however, in order to planarize the surface of the opposite substrate facing the liquid crystal layer, the thickness of the light blocking layer is preferably smaller than the total thickness of the colored layer and the overcoat layer.

The display device of this embodiment is applicable to liquid crystal display devices of so-called vertical electric field system driven in the TN (twisted nematic) mode, the VA (vertical alignment) mode or the MVA (multi-domain vertical alignment) mode and liquid crystal display devices of so-called transverse electric field system driven in the IPS (in-plane switching) mode, the FFS (fringe field switching) mode, or so on. The following description will be given of a display device according to an example by taking as a typical example an FFS mode liquid crystal display device.

### Examples

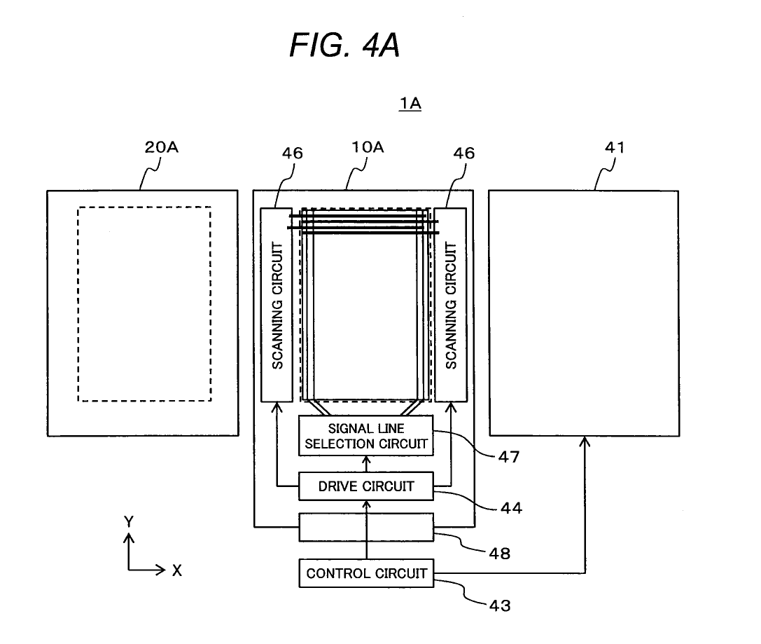

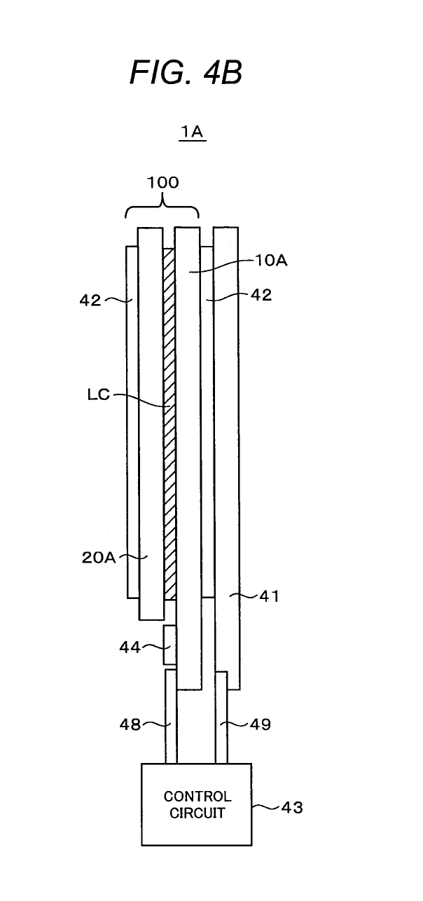

FIG. 4A is a plan view showing substrates of a display device according to an example with the substrates separated from each other. FIG. 4B is a side view of the display device according to this example. The display device 1A according to this example is a liquid crystal display device.

The display device 1A includes a display panel 100, a backlight 41, a control circuit 43, a drive circuit 44, and cables 48, 49. The display device 1A is vertically long (that is, its length in the Y direction is greater than its length in the X direction). The display panel 100 includes, an array substrate (TFT substrate) 10A, an opposite substrate (CF substrate) 20A, a liquid crystal layer LC, and polarizing plates 42. In the array substrate 10A, scanning circuits 46 and a signal line selection circuit 47 are formed of TFT's. The polarizing plates 42 are arranged, one between the backlight 41 and the array substrate 10A and another on the outer surface of the opposite substrate 20A. The drive circuit 44 is formed of a semiconductor integrated circuit (IC), such as CMOS, and mounted on the array substrate 10A by a COG method. The drive circuit 44 is connected via the cable 48 to the control circuit 43. The backlight 41 is connected via the cable 49 to the control circuit 43.

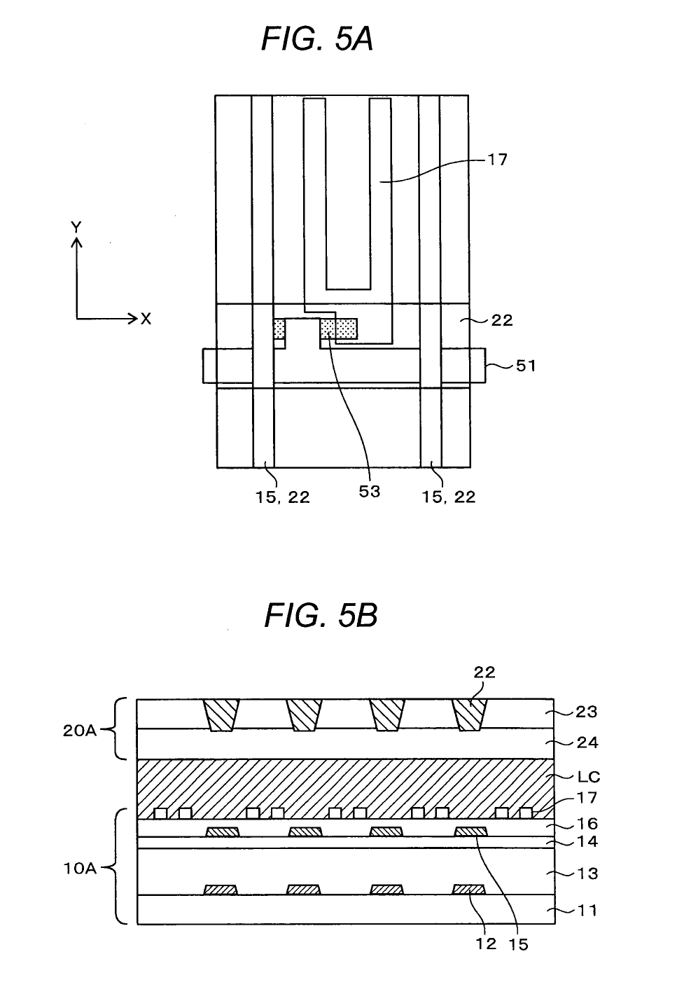

FIG. 5A is a plan view showing a portion of the array substrate in this example. FIG. 5B is a cross-sectional view showing a portion of the display device according to this example.

A gate wiring layer 51 is formed on a transparent substrate made of, for example, glass and a semiconductor layer 53 is formed on the gate wiring layer 51 with a gate insulating layer between them. A signal wiring layer 12 and a drain wiring layer are connected via contact holes in an interlayer insulating layer 11 to the semiconductor layer 53. A common electrode 14 is disposed above the signal wiring layer 12 with an organic insulating layer 13 between them. An auxiliary wiring layer 15 is disposed straight above the signal wiring layer 12 and on and in contact with the common electrode 14. A plurality of pixel electrodes 17 are arranged on the common electrode 14 with an interlayer insulating film 16 between them. The pixel electrodes 17 are connected via contact holes in the organic insulating layer 13 to the drain electrode layer. Each pixel electrode 17 has a slit. The gate wiring layer 51 extends in the X direction and also extends in the Y direction toward the semiconductor layer 53. The auxiliary wiring layer 15 extends in a direction parallel to the signal wiring layer 12 (in the Y direction). The common electrode 14 and the pixel electrodes 17 are each formed of a transparent conductive film, such as ITO, and the auxiliary wiring layer 15 and the signal wiring layer 12 are each formed of a metal film (light-blocking conductive film), such as Al. The auxiliary wiring layer 15 is wiring for use to reduce the resistance of the common electrode 14. Since in this display device 1A the sub-pixels make vertical stripes, the signal wiring layer 12 is formed of video signal lines.

The opposite substrate 20A includes a transparent substrate of glass or so on, a light blocking layer 22, a colored layer 23, and an overcoat layer 24. The light blocking layer 22 is disposed straight above the signal wiring layer 12 and the auxiliary wiring layer 15.

The gate wiring layer 51 and the semiconductor layer 53 are arranged between sub-pixels of the same color. The gate wiring layer 51 and the semiconductor layer 53 are arranged to overlap with the light blocking layer 22 in plan view. The signal wiring layer 12 and the auxiliary wiring layer 15 are arranged between sub-pixels of different colors. The signal wiring layer 12 is disposed to overlap with the auxiliary wiring layer 15 in plan view. The auxiliary wiring layer 15 is disposed to overlap with the light blocking layer 22 in plan view. However, if the array substrate 10A and the opposite substrate 20A have assembly misalignment in the direction across sub-pixels of different colors, the auxiliary wiring layer 15 may have portions not overlapping with the light blocking layer 22 in plan view but still overlaps with it.

A description will be given of a method for producing the opposite substrate.

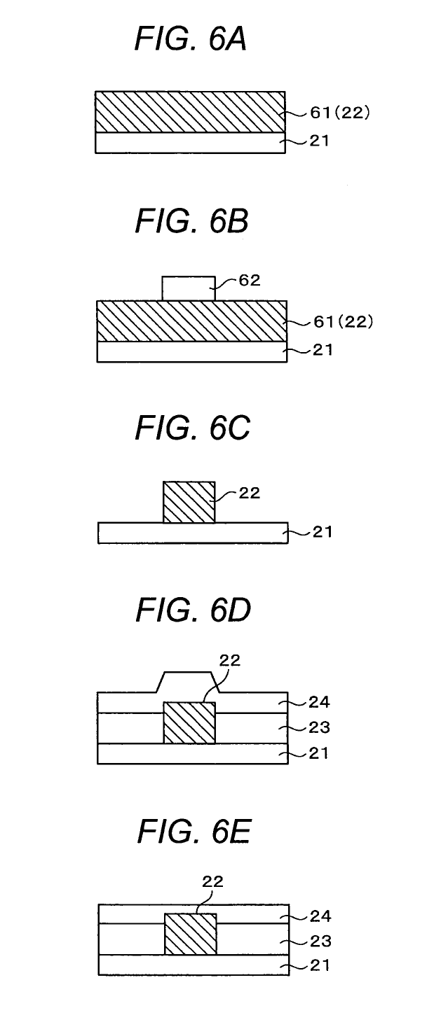

FIGS. 6A to 6D are cross-sectional views for illustrating the method for producing the opposite substrate.

As shown in FIG. 6A, a black resin 61 (22) is applied on a transparent substrate 21. Next, as shown in FIG. 6B, a photoresist 62 is patterned on the black resin 61 (22) by photolithography. Next, as shown in FIG. 6C, the black resin 61 (22) is dry etched with the photoresist 62 as a mask to form a light blocking layer 22. The black resin 61 (22) may be photosensitive or non-photosensitive. If the light blocking layer 22 is desired to be less thick, a photosensitive black resin is applied on the transparent substrate 21 and patterned by photolithography to form a light blocking layer 22. In other words, neither photoresist nor dry etching be used. With the use of the method shown in FIGS. 6A to 6C, a thick light blocking layer can be formed.

As shown in FIG. 6D, a colored layer 23 is formed on the transparent substrate 21 and, then, acrylic resin, polyimide resin or the like is applied over the light blocking layer 22 and the colored layer 23 to form an overcoat layer 24. Because the light blocking layer 22 having a greater thickness than the colored layer 23 provides poor smoothness, a polishing process is introduced, as shown in FIG. 6E, to smooth the overcoat layer 24. If the light blocking layer 22 is desired to be less thick, for example, if the light blocking layer 22 is thinner than the colored layer 23, the polishing process can be omitted.

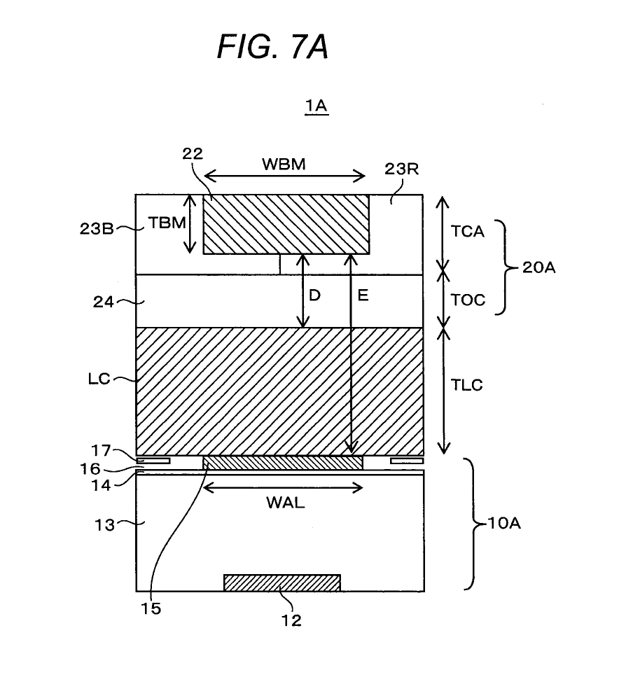

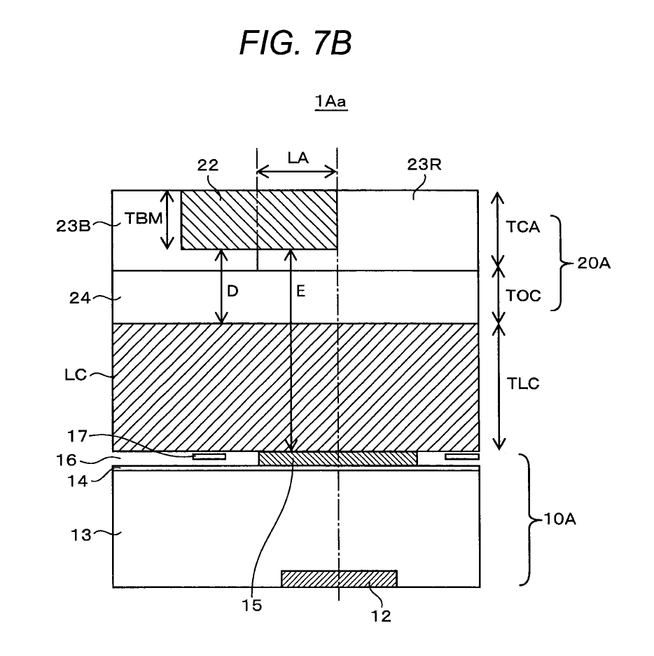

A description will be given of a color mixture ratio with reference to FIGS. 7A to 10.

FIG. 7A is a cross-sectional view of a display device having no assembly misalignment. FIG. 7B is a cross-sectional view of a display device having assembly misalignment.

Various dimensions of a display device 1Aa having assembly misalignment and determined in terms of color mixture ratio are described below. Dimensions of a display device 1A having no assembly misalignment are equal to those of the display device 1Aa, except for the amount of assembly misalignment.

The width (WBM) of the light blocking layer 22 is 4 μm, the thickness (TCA) of the colored layer 23 is 2.0 μm, the thickness (TOC) of the overcoat layer 24 is 1.5 μm, the width (WAL) of the auxiliary wiring layer 15 is 4 μm, the width of the signal wiring layer 12 is 3 μm, and the thickness (TLC) of the liquid crystal layer LC is 3.3 μm. The thickness TLC includes the thickness of the alignment films. Furthermore, the thickness of the interlayer insulating layer 16 is 0.2 μm, the thickness of the auxiliary wiring layer 15 is 0.22 μm, the thickness of the common electrode 14 is 0.05 μm, the thickness of the organic insulating layer 13 is 3 μm, and the thickness of the signal wiring layer 12 is 0.46 μm.

The amount (LA) of assembly misalignment between the array substrate and the opposite substrate is 2 μm and the pixel pitch (WSP) is 16.9 μm (equivalent to a resolution of 500 ppi). The pixel pitch is the width of each sub-pixel in the direction across sub-pixels of different colors.

When the thickness of the interlayer insulating layer 16 is 0.2 μm, the thickness of the auxiliary wiring layer 15 is 0.22 μm, and the thickness of the common electrode 0.05 μm, the auxiliary wiring layer 15 is very close to the liquid crystal LC as shown in FIGS. 7A and 7B. Therefore, in this case, the color mixture ratio substantially depends upon the pixel pitch (WSP), the width (WBM) of the light blocking layer 22, the width (WAL) of the auxiliary wiring layer 15, the thickness (TBM) of the light blocking layer 22, the thickness (TCA) of the colored layer 23, the thickness (TOC) of the overcoat layer 24, and the thickness (TLC) of the liquid crystal layer LC.

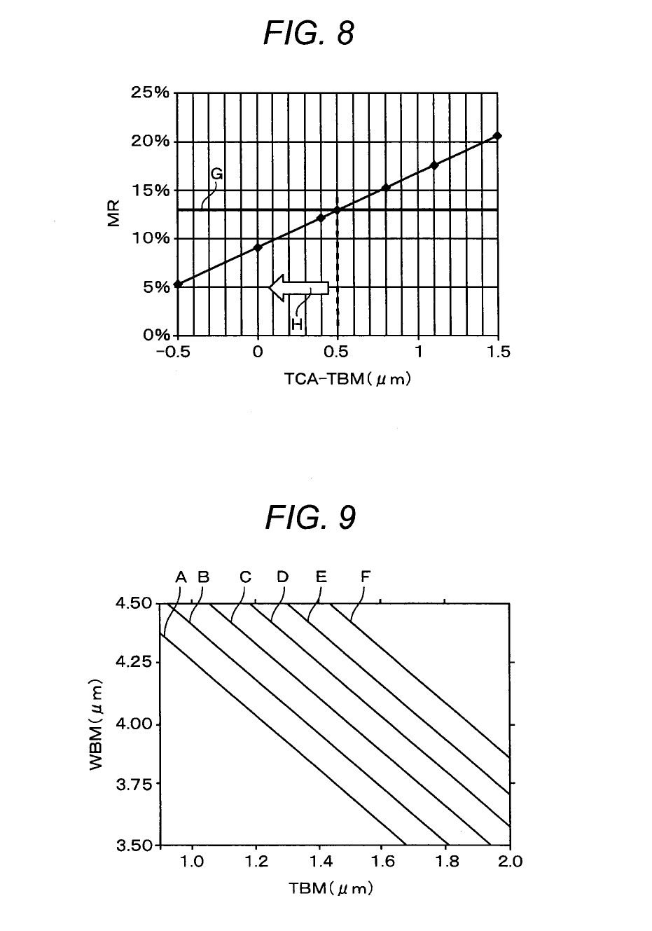

First, a description will be given of the relation between the thickness of the light blocking layer and the color mixture ratio with reference to FIG. 8.

FIG. 8 is a graph showing the relation between the thickness of the light blocking layer and the color mixture ratio. In FIG. 8, TCA−TBM is plotted against the color mixture ratio with changes in the thickness (TBM) of the light blocking layer 22. Assuming that the width of regular light from the relevant sub-pixel is WA and the width of mixed color light from the adjacent sub-pixel is WB, the color mixture ratio (MR)=WB/WA. As the pixel pitch decreases, the width WA also decreases, so that the color mixture ration increases.

As shown in FIG. 8, when TBM=0.5, 0.9, 1.2, 1.5, 1.6, 2.0, and 2.5 (μm), i.e., when TCA−TBM=1.5, 1.1, 0.8, 0.5, 0.4, 0, and −0.5 (μm), MR=20, 17, 15, 13, 12, 9, and 5(%), respectively. It is confirmed from experiments that when MR≦13% (the value of MR is on or below the line G), color mixture is at a well-controlled level. In other words, a well-controlled level of color mixture is not MR=0% but need only be equal to or smaller than the predetermined value. Therefore, as shown by the arrow H, when TCA−TBM≦0.5 (μm), i.e., TBM≧1.5 (μm), color mixture is at a well-controlled level. Furthermore, when TBM>D=TCA+TOC−TBM (TBM>(TCA+TOC)/2), color mixture is at a better-controlled level. It is preferred to satisfy the following relation: TBM<TCA+TOC=3.5 (μm). In view of optical density, TBM is preferably 0.9 μm or more. When WSP≧16.9 μm (not more than 500 ppi) and TCA−TBM≦0.5, color mixture is at a well-controlled level. Moreover, even when WSP<16.9 μm (more than 500 ppi), color mixture can be at a well-controlled level by further decreasing TCA−TEM (further increasing TBM).

By increasing the thickness of the light blocking layer 22, the display device with high definition and high aperture ratio can reduce color mixture without reducing the transmittance of the display panel.

Next, a description will be given of a relation among the thickness of the light blocking layer, the width of the light blocking layer, and the color mixture ratio with reference to FIG. 9.

FIG. 9 is a graph showing the relation among the thickness of the light blocking layer, the width of the light blocking layer, and the color mixture ratio.

The dimensions of the display device 1Aa having assembly misalignment and determined in terms of color mixture ratio are the same as those in the case of FIG. 7B, except for the thickness of the light blocking layer and the width of the light blocking layer. Color mixture is at a well-controlled level if the following relation (1) is satisfied where the thickness of the light blocking layer 22 is TBM (μm) and the width of the light blocking layer 22 is WBM (μm).

WBM≧−1.11×TBM+5.67 (1)

In FIG. 9, the line A indicates MR=15%, the line B indicates MR=14%, the line C indicates MR=13%, the line D indicates MR=12%, the line E indicates MR=11%, and the line F indicates MR=10%. When the coordinate is on the line C and to the right of the line C, i.e., when MR≦13%, color mixture is at a well-controlled level. Like the case shown in FIG. 7B, the width WBM is equal to the width WAL.

If the width of the light blocking layer 22 is desired to be decreased, the thickness of the light blocking layer 22 is preferably concurrently increased. The dimensions of the display device are not limited to those in the case of FIG. 7B. Also when the above relation (1) is satisfied under the conditions that WSP≧16.9 μm, TCA≦2.0 μm, TOC≦1.5 μm, and TLC≦3.3 μm, color mixture is at a well-controlled level. In this regard, it is preferred to satisfy the following relation: TBM<TCA+TOC=3.5 (μm). Therefore, the lower limit of WBM is approximately 1.8 μm. In view of optical density, TBM is preferably 0.9 μm or more.

Even if WSP<16.9 μm, color mixture can be at a well-controlled level by further increasing TBM. When WSP<16.9 μm, the boundary where color mixture comes to a well-controlled level shifts to the right of the line C (toward the line F).

When WBM=4.5, it follows from the above relation (1) that TBM=1.05, D=2.45, and therefore TBM<D. Likewise, when WBM=4, it follows that TBM=1.50, D=2.00, and therefore TBM<D. When WBM=3.73, it follows that TBM=1.75, D=1.75, and therefore TBM=D. When WBM=3.5, it follows that TBM=1.95, D=1.55, and therefore TBM>D. When WBM≧3.73, color mixture is at a well-controlled level if the relation TBM>D is satisfied. When WBM<3.73, color mixture is at a well-controlled level if TBM>D and TBM is greater than a predetermined value.

When 3.5≦WBM≦4.5, color mixture is at a well-controlled level if TBM≧TCA=2.0. Even when TBM<TCA=2.0, color mixture is in some cases at a well-controlled level.

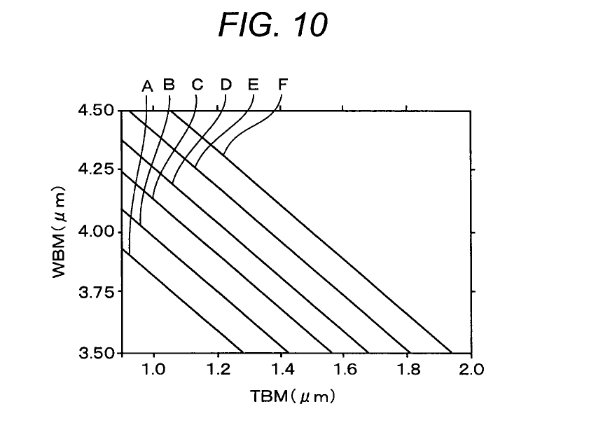

Next, a description will be given of a relation among the thickness of the light blocking layer, the width of the light blocking layer, and the color mixture ratio when the thicknesses of the color layer 23, the overcoat layer 24 and the liquid crystal LC are changed, with reference to FIG. 10.

FIG. 10 is a graph showing another relation among the thickness of the light blocking layer, the width of the light blocking layer, and the color mixture ratio.

In this case, the dimensions of the display device 1Aa having assembly misalignment and determined in terms of color mixture ratio are different from the case of FIG. 9 in that the thicknesses of the colored layer 23, the overcoat layer 24, and the liquid crystal layer LC are decreased. Specifically, the thickness (TCA) of the colored layer 23 is 1.6 μm, the thickness (TOC) of the overcoat layer 24 is 1.0 μm, and the thickness (TLC) of the liquid crystal layer LC is 3.0 μm. The other dimensions of the display device 1Aa are the same as those in the case of FIG. 7B. In the case of FIG. 10, color mixture is at a well-controlled level when the following relation (2) is satisfied.

WBM≧−1.07×TBM+5.21 (2)

Like the case of FIG. 9, the line A indicates MR=15%, the line B indicates MR=14%, the line C indicates MR=13%, the line D indicates MR=12%, the line E indicates MR=11%, and the line F indicates MR=10%. When the coordinate is on the line C and to the right of the line C, i.e., when MR 13%, color mixture is at a well-controlled level. Like the case shown in FIG. 7B, the width WBM is equal to the width WAL.

Like the case of FIG. 9, if the width of the light blocking layer 22 is desired to be decreased, the thickness of the light blocking layer 22 is preferably concurrently increased. Furthermore, by decreasing the thicknesses of the colored layer 23, the overcoat layer 24, and the liquid crystal layer LC, color mixture is at a better-controlled level than the case of FIG. 9. In other words, TBM may be smaller than that in the case of FIG. 9. Also when the relation (2) is satisfied under the conditions that the pixel pitch is 16.9 μm or more, TCA is 1.6 μm or less, TOC is 1.0 μm or less, and TLC is 3.0 μm or less, color mixture is at a well-controlled level. In this regard, it is preferred to satisfy the following relation: TBM<TCA+TOC=2.6 (μm). Therefore, the lower limit of WBM is approximately 2.4 μm. In view of optical density, TBM is preferably 0.9 μm or more.

When WBM=4.5, it follows from the above relation (2) that TBM=0.66, D=1.94, and therefore TBM<D. Likewise, when WBM=4, it follows that TBM=1.13, D=1.47, and therefore TBM<D. When WBM=3.82, it follows that TBM=1.30, D=1.30, and therefore TBM=D. When WBM=3.5, it follows that TBM=1.60, D=1.00, and therefore TBM>D. When WBM≧3.82, color mixture is at a well-controlled level if the relation TBM>D is satisfied. When WBM<3.82, color mixture is at a well-controlled level if TBM>D and TBM is greater than a predetermined value.

When 3.5≦WBM≦4.5, color mixture is at a well-controlled level if TBM≧TCA=1.6. Even when TBM<TCA=1.6, color mixture is in some cases at a well-controlled level.

What is claimed is:

1. A display device comprising a display panel and a light source,
wherein the display panel comprises an array substrate, an opposite substrate, and a liquid crystal layer sandwiched between the array substrate and the opposite substrate,
the opposite substrate comprises a first light blocking layer, a colored layer, and an overcoat layer,
the array substrate comprises a second light blocking layer and a signal wiring layer,
the light source is disposed on an opposite side of the array substrate to the liquid crystal layer,
the first light blocking layer, the second light blocking layer, and the signal wiring layer are disposed between sub-pixels of different colors,
the second light blocking layer is disposed close to the liquid crystal layer, and
a distance between a top surface of the first light blocking layer and a top surface of the second light blocking layer is decreased by increasing a thickness of the first light blocking layer, decreasing a thickness of the colored layer, decreasing a thickness of the overcoat layer or decreasing a thickness of the liquid crystal layer.

2. The display device according to claim 1, wherein the thickness of the first light blocking layer is greater than a distance between facing surfaces of both the first light blocking layer and the liquid crystal layer.

3. The display device according to claim 2, wherein the thickness of the first light blocking layer is smaller than a total thickness of the colored layer and the overcoat layer.

4. The display device according to claim 2, wherein the thickness of the first light blocking layer is smaller than the thickness of the colored layer.

5. The display device according to claim 1, wherein the thickness of the first light blocking layer is greater than the thickness of the colored layer.

6. The display device according to claim 5, wherein the thickness of the first light blocking layer is smaller than a total thickness of the colored layer and the overcoat layer.

7. The display device according to claim 1, wherein the first light blocking layer is disposed to overlap with the second light blocking layer in plan view.

8. The display device according to claim 1,
wherein the array substrate comprises a common electrode and a pixel electrode, and
the second light blocking layer is a metal wiring layer disposed on and in contact with the common electrode.

9. The display device according to claim 8, wherein the array substrate comprises: an organic insulating layer covering the signal wiring layer; and an interlayer insulating layer covering the common electrode and the second light blocking layer.

10. The display device according to claim 1,
wherein the signal wiring layer is formed of a light-blocking metal film, and
the first light blocking layer, the second light blocking layer, and the signal wiring layer are disposed to overlap with each other in plan view.

11. The display device according to claim 1, wherein the first light blocking layer has a width of 4.5 μm or less.

12. The display device according to claim 11, wherein the colored layer has a thickness of 2.0 μm or less.

13. The display device according to claim 11, wherein the overcoat layer has a thickness of 1.5 μm or less.

14. The display device according to claim 11, wherein the liquid crystal layer has a thickness of 3.3 μm or less.

15. A display device comprising a display panel and a backlight,
wherein the display panel comprises an array substrate, an opposite substrate, and a liquid crystal layer sandwiched between the array substrate and the opposite substrate,
the opposite substrate comprises a first light blocking layer, a colored layer, and an overcoat layer,
the array substrate comprises a second light blocking layer and a signal wiring layer,
the first light blocking layer and the second light blocking layer are disposed between sub-pixels of different colors,
the second light blocking layer is disposed close to the liquid crystal layer, and
the first light blocking layer has a width of 4.5 μm or less.

16. The display device according to claim 15, wherein the display device is configured to satisfy a relation WBM≧−1.11×TBM+5.67 where WBM represents a width (μm) of the first light blocking layer and TBM represents a thickness (μm) of the first light blocking layer and when a pixel pitch is 16.9 μm or more, the colored layer has a thickness of 2.0 μm or less, the overcoat layer has a thickness of 1.5 μm or less, the liquid crystal layer has a thickness of 3.3 μm or less, and the first and second light blocking layers have the same width.

17. The display device according to claim 15, wherein the display device is configured to satisfy a relation WBM≧−1.07×TBM+5.21 where WBM represents a width (μm) of the first light blocking layer and TBM represents a thickness (μm) of the first light blocking layer and when a pixel pitch is 16.9 μm or more, the colored layer has a thickness of 1.6 μm or less, the overcoat layer has a thickness of 1.0 μm or less, the liquid crystal layer has a thickness of 3.0 μm or less, and the first and second light blocking layers have the same width.

18. The display device according to claim 15, wherein the colored layer has a thickness of 2.0 μm or less, the overcoat layer has a thickness of 1.5 μm or less, the liquid crystal layer has a thickness of 3.3 μm or less, and the first light blocking layer has a thickness of 1.5 μm or more.

19. The display device according to claim 15, wherein the colored layer has a thickness of 1.6 μm or less, the overcoat layer has a thickness of 1.0 μm or less, the liquid crystal layer has a thickness of 3.0 μm or less, and the first light blocking layer has a thickness of 1.2 μm or more.
